(19) United States
(12) Patent Application Publication
(10) Pub. No.: US 2004/0086221 A1
(43) Pub. Date: May 6, 2004

(54) Low cost, hybrid integrated dense wavelength division multiplexer/demultiplexer for fiber optical networks

(76) Inventors: Wei Qiu, Gardena, CA (US); Zhanxiang Zhang, San Jose, CA (US); Jianmin Gao, San Jose, CA (US); Dong Xu, San Jose, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/290,098

(22) Filed: Nov. 6, 2002

(51) Int. Cl. G02B 6/293

(52) U.S. Cl. 385/24

(57) ABSTRACT

A first embodiment of the present invention provides a dense wavelength division multiplexer which has a planar array of input optical channels, each channel capable of receiving an optical signal. Coupled to this planar array of input channels is a first waveguide concentrator which facilitates the reduction of the spacing between the cores of the input optical channels. A first collimating provides means for transforming the optical signals into a collimated beam. A wavelength dependent element is disposed proximate the first collimating means. A second collimating means refocuses the collimated beam into an optical channel in a second waveguide concentrator, which facilitates the expansion of the spacing between the cores of the output channels, and ultimately to an array of output optical channels.

### FIELD OF THE INVENTION

The present invention relates to dense wavelength division multiplexing and demultiplexing (DWDM).

### BACKGROUND OF THE INVENTION

In a DWDM system, multiple signal sources emitting at slightly different wavelengths, λ1, λ2, . . . λn, are coupled into the same single mode fiber by means of a multiplexer. After the signals of different wavelengths are transmitted through the fiber to a desired destination, the multiple wavelength signal carried by the single fiber must then be separated by means of a demultiplexer into separate optical channels.

Conventional DWDM multiplexers and demultiplexers employ fused couplers, thin film filters, diffraction gratings, array waveguide gratings (AWG), or BRAGG in-fiber gratings. The AWG approach uses only waveguides, no filters, is small but not stable enough for a wavelength channel. Without a temperature controller, the wavelength channel would shift with temperature. A particular conventional DWDM multi-channeled multiplexer and demultiplexer employs a number of filters and GRIN lens, one filter adapted for passing one of the wavelengths. An example of such a multiplexer and demultiplexer is current commercial Cascaded Eight-channel Multiplexing and Demultiplexing Module from JDS Uniphase, Dicon fiberoptics, Oplik Communications, Tycoelectronics, and etc. In such a demultiplexing scheme, seven filters are used for demultiplexing eight wavelengths in a single channel. Each of the filters is used to pass one of the wavelengths and to reflect the remaining wavelengths. Such conventional schemes are disadvantageous since multiple filters are required as well as multiple optical parts, like GRIN lens, which ultimately make the system bulky and costly.

U.S. Pat. No. 5,737,104 discloses a DWDM scheme in which a characteristic thin film filter is utilized. The center wavelength or edge wavelength of the thin film filter changes with the incident angle to the thin film filter. However this scheme necessitates multiple GRIN lenses, each channel requiring two GRIN lenses. The present requirement for multiplexers or demultiplexers in the telecommunication industry today dictates the need for the center wavelength accuracy to be in the region of 0.1 nm or better. This particular implementation disclosed necessitates either a very big filter area or a very long optical path to achieve a 0.1 nm or better wavelength tuning. This architecture ultimately leads to a system that is bulky. U.S. Pat. No. 5,796,889 discloses a modification of this arrangement, in which the radii of all the input and output fibers are equidistant from the longitudinal axis of the fiber itself, hence limiting the number of input and output fibers that can be accommodated. U.S. Pat. No. 6,055,347 discloses another such modification with the same limitations.

U.S. Pat. No. 5,457,760 discloses another WDM system in which an input waveguide is employed. The input waveguide includes a wavelength selective configuration of optical filtering elements formed within a contiguous portion of the waveguide forming an optical channel-selected filter having an optical transmission pass band and spectral regions of low transmissivity. The disclosure indicates that exemplary optical filtering elements are BRAGG gratings formed into an optical fiber which transmits a characteristic wavelength band. The BRAGG gratings disclosed require that different wavelength grooves be formed in optical fibers, an architecture that is difficult to implement. Furthermore, the disclosed scheme requires that the light carried by an input channel to be demultiplexed be split into a number of output channels, thereby degrading signal-to-noise ratio. A device incorporating this scheme is highly temperature sensitive and consequently temperature stabilization is required.

FIG. 1 is a diagram illustrating a 2×2 WDM coupler scheme 10 found in the prior art. The cladding and core of a pair of optical fibers are fused together to form a WDM coupler enclosed by dotted line 12. The coupler has two input fibers 14, 16, and two output fibers 18, 20. The input fibers 14,16 carry signals of wavelength λ1 and λ2 respectively. Ideally, only one of the output fibers, say output fiber 18, should carry the signals of wavelength λ1, while the other output fiber 20 should carry the signals of wavelength λ2. Crosstalk occurs if the λ1 signals appear on the output fiber 20 or the λ2 signals appear on the output fiber 18. The problem with this WDM coupler and isolator arrangement is the crosstalk between the input fibers, carrying the reflected λ1 signals. Besides crosstalk, another problem is that the insertion losses and polarization dependent losses of such couplers are high. Additionally, the device is rather large, which has an adverse effect upon the reliability and robustness of the device.

### OBJECTS AND ADVANTAGES OF THE INVENTION

The prior art DWDM devices are not entirely satisfactory, requiring multiple filters and lenses, and adopting a coaxial arrangement for the input and output fibers. It is the inherent spacing between the waveguide cores of the input fibers that has dictated in current devices that the architectures adopt a coaxial arrangement. In contrast, the present invention avoids, or substantially mitigates, the problems of the previous schemes by using a waveguide concentrator, a device which allows the spacing of the cores of the fibers to be reduced. In addition, the present invention utilizes one filter and two lenses to build a multiple channel DWDM. A multi-channel fiberoptic dense (100-GHz or better) wavelength division multiplexer/demultiplexer according to the present invention has a higher optical performance, compact, low-cost, using only one DWDM filter and two GRIN lens with low temperature sensitivity, high reliability and robustness. In addition, the size of the resulting device is approximately 50% of prior art devices, and unlike the AWG approach, requires no temperature controller.

The present invention also provides for a planar array of optical fibers to be utilized in a switching architecture, thereby reducing the overall bulkiness of the device, and easing manufacturing issues.

### SUMMARY OF THE INVENTION

In a first aspect, the present invention provides a dense wavelength division multiplexer which has a planar array of input optical channels, each channel capable of receiving an optical signal. Coupled to this planar array of input channels is a first waveguide concentrator which facilitates the reduction of the spacing between the cores of the input optical channels. A first collimating means provides for transforming the optical signals into a collimated beam. A wavelength dependent element is disposed proximate the first collimating means. A second collimating means refocuses the collimated beam into an optical channel in a second waveguide concentrator, which facilitates the expansion of the spacing between the cores of the output channels, and ultimately to an array of output optical channels.

In a second embodiment of the invention, a dense wavelength division demultiplexer is provided, with a planar array of input optical channels, including at least two input channels; a first waveguide concentrator for facilitating the reduction of spacing between the input optical channels; a first collimating means for transforming the optical signals into a collimated beam; a wavelength dependent element; a second collimating means for refocusing the collimated beam into an optical channel; a second waveguide concentrator for facilitating the expansion of spacing between output channels; and the array of output optical channels.

Advantageously, the first waveguide concentrator and the array of input optical channels are integrated.

Advantageously, the second waveguide concentrator and the array of output optical channels are integrated.

This invention will be better understood upon reference to the following detailed description in connection with the accompanying drawings.

### BRIEF DESCRIPTION OF THE DRAWINGS

FIG. 1 is a schematic representation of a 2×2 WDM incorporating fused fibers.

FIG. 2 is a schematic representation of a thin film Dense Wavelength Division Demultiplexer, according to an embodiment of the invention.

FIG. 3 is a schematic representation of a thin film Dense Wavelength Division Multiplexer, according to an embodiment of the invention.

FIG. 4A illustrates a cross-sectional view of a planar array of input/output optical channels..

FIG. 4B illustrates a cross-sectional view of a planar array of input/output optical channels using silicon V-groove technology.

FIG. 5 illustrates an example of coupling between the waveguide concentrators and the optical fiber array

FIGS. 6A through C illustrate the effects of varying collimating beam angle to the collimating axis on the distance of light point from collimating lens.

FIG. 7A illustrate the effects of varying incident angle on the center wavelength of a narrow band pass filter.

FIG. 7B is a graphical illustration of the narrow bandpass characteristics of a filter.

FIG. 7C is a graphical illustration of the long-pass characteristics of a filter.

FIG. 7D is a graphical illustration of the short-pass characteristics of a filter.

FIG. 8 is a schematic representation of a DWDM demultiplexer according to an embodiment of the invention.

FIG. 9 is a schematic representation of a DWDM multiplexer according to an embodiment of the invention

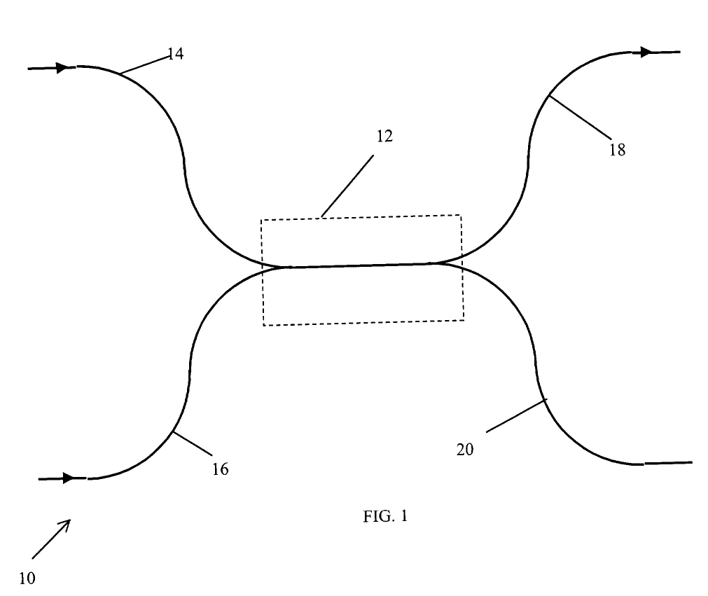

### DESCRIPTION

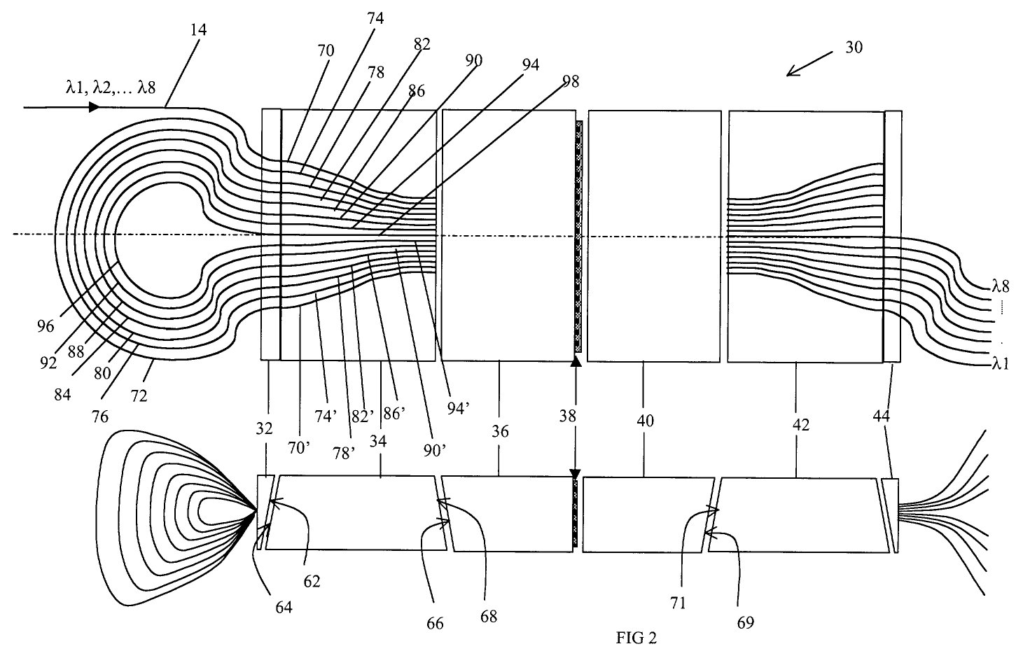

FIG. 2 illustrates an embodiment of a DWDM device 30 in accordance with aspects of the present invention. The compact DWDM demultiplexer 30 is shown to include several major components, a planar array of input optical channels 32, a first waveguide concentrator 34, a first collimating means 36, a waveguide dependent element 38, a second collimating means 40, a second waveguide concentrator 42 and a planar array of output optical channels 44.

Optical signals are received from a planar array of input optical channels 32, in which the optical channels, preferably waveguides, are arranged at a first separation 46 (refer to FIG. 5) of 125-μm or 250-μm, depending upon the type of planar array employed. Hence the input end of the first waveguide concentrator 34 will substantially match the planar array of input optical channels 32. By matching, we mean that the optical axes of the planar array of optical inputs 32 are substantially optically aligned with the input end optical axes of the first waveguide concentrator 34. The output end of the waveguide concentrator 34, the dense waveguide end, is arranged such that the light from each distinct optical waveguide can subsequently be collimated by the first collimating means 36 and have its own distinct angle to enter the wavelength dependent element 38 with.

The wavelength dependent element 38, for example a filter, operates such that optical signals either pass through the filter 38, or are blocked, dependent upon the wavelength of the light signals. The angle at which light enters the wavelength dependent element is the determining factor as to which wavelength of light passes the element and which wavelengths are blocked. In the various embodiments of the present invention described below, bandpass filters, longpass filters, and shortpass filters can be used. These light beams, each with their own angle will have their own central wavelength of filter 38.

The light from a first optical channel 70 in the waveguide concentrator 34 is collimated after a pass through the first collimating means 36 toward the wavelength dependent element 38. Any light which is blocked by the filter 38 is reflected back through the first collimating means 36 and is refocused and propagates into a second optical channel 70′ in the first waveguide concentrator 34. Any light which passes through the filter 38 goes on to through the second collimating means 40 and is refocused and propagates into a second optical channel in the second waveguide concentrator 42. Thus the wavelength dependent element 38 is designed such that the light from an input optical channel is refocused into a predetermined output optical channel.

The input end, the dense waveguide end, of the second waveguide concentrator 42 will substantially match the output from the wavelength dependent element 38. Optical signals passing through the wavelength dependent element 38 continue towards the optical channels of the second waveguide concentrator 42, exiting at a second separation of 125-μm or 250-μm, depending upon the type of optical channel array employed at the output end of the device 30.

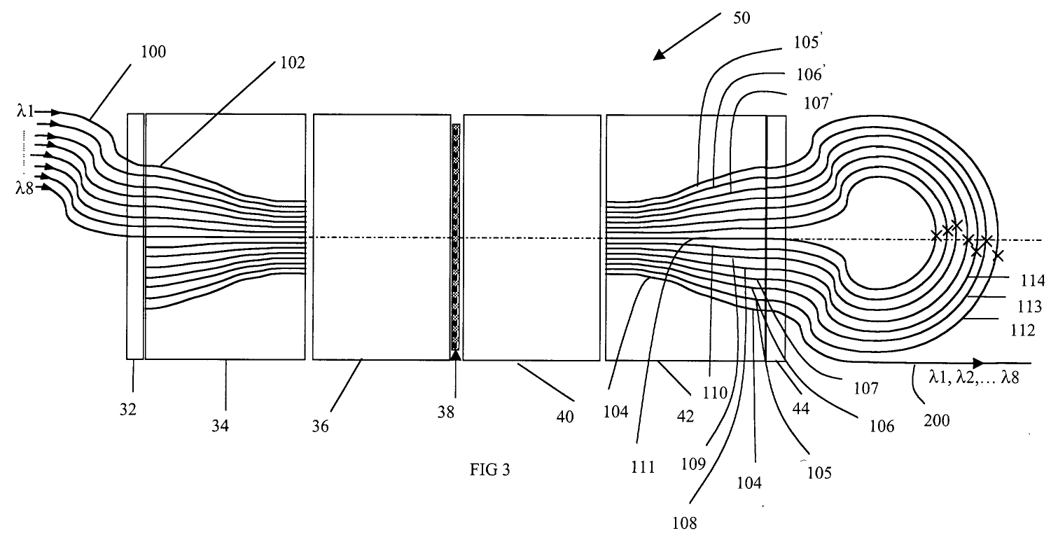

The current invention covers multiplexers and demultiplexers that are constructed using the architecture described above in which the wavelength dependent element has a characteristic property wherein the wavelength band varies as a function of the angle of incidence. The compact DWDM multiplexer 50 is illustrated in FIG. 3.

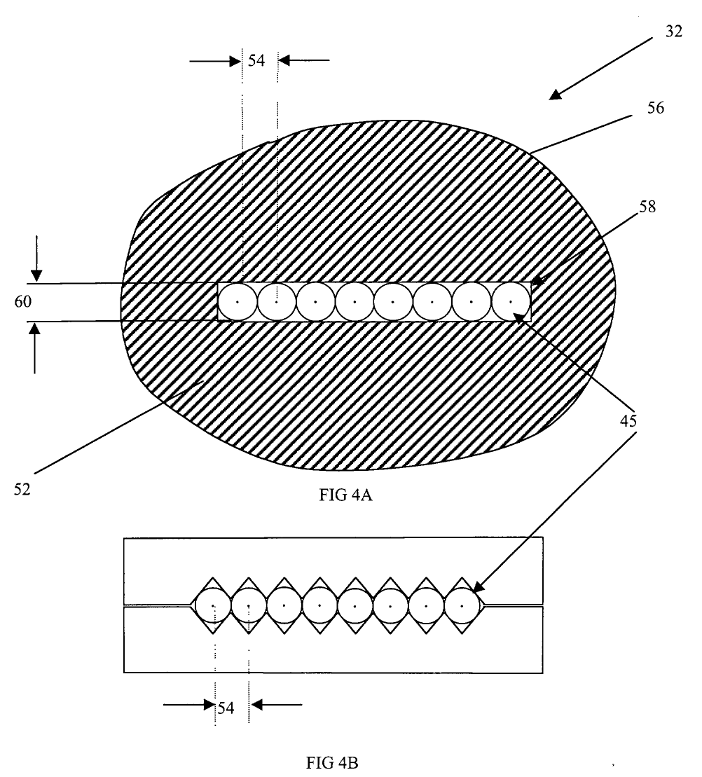

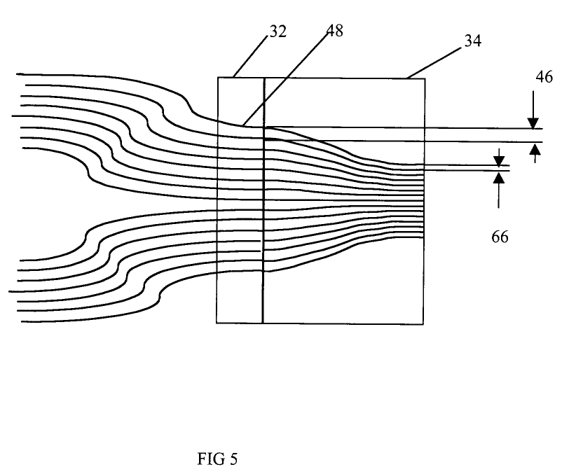

FIG. 4A illustrates a cross-sectional view of the planar array of input optical channels 32, for example an optical fiber ribbon, comprising multiple optical fibers 45, each optical fiber having an associated output port, the center 52 of each output port being laterally spaced apart from its neighbor by a first separation 54. In the configuration shown, the multiple optical fibers 45 are accommodated within a sleeve 56, which has an aperture 58 in the middle thereof. The ends of the optical fibers are unjacketed so that the planar array of optical channels comprises only the core and cladding of the fibers. In an embodiment where the optical fibers are unjacketed and the end sections of fibers are untapered, the cross-sectional diameter of each of these single mode fibers is typically about 125 microns and linearly accommodated in the aperture 58. The width 60 of aperture 58 is 125 microns, which just allows standard optical fiber to go through. The length of aperture 58 depends on the number of channels to multiplexed/demultiplexed. For example, an 8-channel demultiplexer requires a total of 16 optical fibers, a length of 2000 microns.

An alternative method to realize a planar array of input or output optical channels is using silicon V-groove technology as shown in FIG. 4B. The position of the V-grooves can be defined precisely by using photolithography. The defined position of single crystal silicon is etched to make the groove with the width that can just hold a fiber. All of the V-grooves have substantially the same shape, angle and width. The width is designed to just accomodate a fiber in the V-groove. When all the optical fibers are placed into all the V-grooves, and clamped tightly, automatically, the fiber array will be aligned linearly.

Referring back to FIG. 2, the face 62 of the planar array of input channels 32 and the ends of fibers facing towards the first waveguide concentrator 34 is polished at an angle about 8° from a plane perpendicular to the longitudinal axis of the planar array 32. The input face 64 of the first waveguide concentrator 34 is also angle-polished, to be reciprocal to the face of the planar array 32. Anti-reflection coatings are deposited on the face 62 of the planar array 32 and the input face 64 of the first waveguide concentrator 34. The face 62 of the planar array 32 and the input face 64 of the first waveguide concentrator 34 are then brought together in close proximity with the angle of their faces in a parallel and reciprocal relationship. The separation distance between these two faces is several micrometers. The planar array 32 and first waveguide concentrator 34 may be placed in a quartz cylinder which holds the ends of the optical fibers, the planar array 32, and the first waveguide concentrator 34 centered in a cylindrical housing to form a complete assembly. Epoxy is used to hold the assembly together.

FIG. 5 illustrates the function of the first waveguide concentrator 34. As illustrated, optical signals from the output ports of the planar optical array 32 communicate with the input ports of the first waveguide concentrator 34. The first waveguide concentrator is responsible for taking the optical inputs ports from the optical fiber at a first separation 46, and converting the separation such that the optical inputs are spatially separated from one another at a second separation 66 (usually a smaller separation), and ensuring that the light exiting from each optical port of the output end of the first waveguide concentrator 34, exits through the collimating means with its own distinct angle such that it will define its own central wavelength for the wavelength dependent element 38, in due course. The concept is to provide an output in which it appears that each optical channel in the waveguide concentrator 34 has a filter with slight different central wavelength that the other optical channels. The central wavelength depends on the location of optical channel in waveguide concentrator. Provided one knows the wavelength required, the waveguide position can be decided.

The waveguide concentrator may comprise fused silica planar waveguide technology, or ion-exchanged glass waveguide technology, for example, no matter what the technology used, the optical channels 48 have to be design such that the optical mode, size and shape in the input end of the first waveguide concentrator 34 match as close as possible to the planar array of optical channels 32 in order to minimizing the coupling loss between the two elements.

The first collimating means 36, for example a GRIN (Graded Index) lens, collimates light received from an optical channel 48 in the first waveguide concentrator 34 (which appear as point sources) toward the wavelength dependent element 38.

Conventional homogeneous lens might also be used in place of the GRIN lens in this invention, though GRIN lens are believed to be superior in the balance of factors, such as size, cost, performance, assembly and reliability in the completed device, and reliability considerations when the working area is less than 1-mm in diameter. Nonetheless, conventional collimating lenses, including homogeneous and aspheric lenses, might be used in place of the quarter pitch GRIN lenses. As mentioned above, the pitch of the GRIN lenses may be slightly less than a true quarter pitch, so that the light from each waveguide may be formed with a properly collimating beam.

Referring once again to FIG. 2, it can be seen that the input face 66 of the first collimiating means 36, the face towards the first waveguide concentrator 34, is angle-polished. The adjacent output face 68 of the first waveguide concentrator is angle-polished at a reciprocal angle.

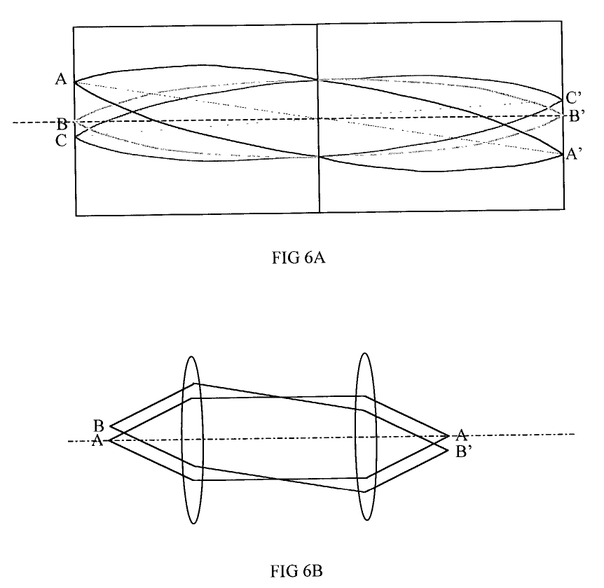

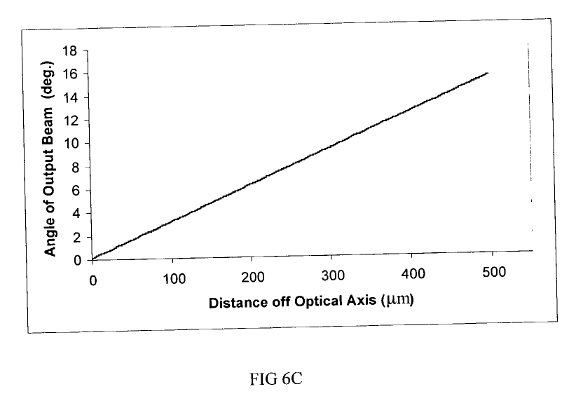

FIG. 6A illustrates the action of a quarter-pitch GRIN lens. The GRIN lens has a longitudinal axis. A point source of light A at one surface of the lens on the axis appears as a collimated beam that propagates parallel to the GRIN lens longitudinal axis. This is shown by a tracing of rays from point A to point A′. A point B at one surface of the GRIN lens but slightly off the longitudinal axis appears as a collimated beam as well, but the beam propagation direction has a slight angle to the GRIN lens longitudinal axis. This is shown by a tracing of rays from point B to point B′. Similary point C appears as a collimiated beam at point C′. FIG. 6B illustrates the tracing of light rays as they pass through a conventional lens arrangement designed to operate like a quarter-pitch GRIN lens. The relationship between the angles of collimated beam propagation direction to the GRIN lens axis and the distance of point B to the lens axis is graphically illustrated in FIG. 6C.

In theory, the GRIN lens used in the devices described is quarter pitch, put in practice it has been found that 0.23 pitch offers better collimating performance. While standard lenses could also be used as collimators, it has been found that GRIN lenses provide better performance, easier manufacturing, and greater durability when the working area is less than the diameter of 1.0 millimeter.

The element 38 is wavelength-dependent (for example a filter), i.e., light signals through the element are blocked or passed dependent upon the wavelength of the light signals. In the various embodiments of the present invention described below, bandpass filters, longpass filters, and shortpass filters are used. Each of the distinct light beams entering the wavelength dependent element 38 will have its own central wavelength associated with the element 38, as described above. Hence it will appear that each optical channel in the waveguide concentrator has associated with it, a filter with a slightly different central wavelength than the neighboring optical channels. The central wavelength depends on the location of optical channel in first waveguide concentrator 34. As long as one knows the precise wavelength required, the waveguide position is dictated.

The back face 69 of the GRIN lens (the second collimiating means 40) is polished at an angle, (shown here at an exaggerated angle). typically, the polished angle is 6 to 12 degrees from a flat surface perpendicular to the longitudinal axis of the GRIN lens. Both the end-face of lens 40 and the front face 71 of the second waveguide concentrator 42 preferably have an anti-reflective coating deposited thereon. Similar to the front end of the device, the front face 71 of waveguide concentrator 42 and the back face 69 of the GRIN lens 40 are then brought together in close proximity with the angle of their faces in parallel and reciprocal relationship. The separation distance is several micrometers when using a quarter pitch GRIN lens and several hundred micrometers when using a 0.23 pitch GRIN lens. The GRIN lens may be placed in a quartz cylinder with almost the same outlet size as the cylinder used for holding the second waveguide concentrator. The housing forms the outer cover of the waveguide concentrator sub-assembly and GRIN lens. Epoxy holds the GRIN and fiber/waveguide sub-assembly together.

Returning to FIG. 2, the schematic diagram of a demultiplexer can be used to illustrate how an input beam containing light of eight wavelengths with 100-GHz spacing is demultiplexed by means of a single filter having the characteristic properties of a characteristic wavelength band that varies with the angle of incidence in the manner described above. The filter may be a bandpass filter or an edge filter as described above. As shown in FIG. 2, an input fiber 14 carry an input beam containing light of eight wavelengths: λ₁ through λ₈. The difference between adjacent wavelengths is 0.8 nm (100-GHz) or 0.4 nm (50-GHz).

The input fiber 14 allows propagation of light into the first optical channel 70 of first waveguide concentrator 34. This light propagates and is directed and collimated by first collimating means 36 at a first angle of incidence α₁ towards the filter (wavelength dependent element 38). The filter is selected so that light of wavelength λ₁ passes through the filter and light of the remaining wavelengths λ₂ through λ₈ are reflected by the filter.

The reflected light is collected by the first collimating means 36 and is focused on a second optical channel 70′ in first waveguide concentrator 34. This optical channel 70′ couples the light into a second optical fiber 72 which conveys the light to a third optical channel 74 in the first waveguide concentrator 34. The light from the second optical channel 74 is collimated and directed towards the filter 38 at a second incidence angle α₂ to the normal direction. The second incidence angle α₂ being different from the first incident angle α₂ of optical channel 70. The second incidence angle α₂ is chosen so that at wavelength λ₂ it is 0.8-nm for 100-GHz or 0.4-nm for 50-GHz longer than λ₁, and passes through the filter but light of the remaining wavelengths, namely, λ₃ through λ₈ are reflected by the filter.

This reflected light is collected by the first collimating means 36 and focused on a fourth optical channel 74′ in the first waveguide concentrator 34. This fourth optical channel 74′ couples light into a third optical fiber 76 which conveys the light into a fifth optical channel 78 in the first waveguide concentrator 34, and directs the light towards the filter at a third incidence angle α₃ to the normal direction. The third incidence angle α₃ being different from the first incident angle α₁ of the first optical channel 70 and the second incident angle α₂. The third incidence angle α₃ is chosen so that at wavelength λ₃ it is 0.8-nm for 100-GHz or 0.4-nm for 50-GHz longer than λ₂, and passes through the filter but light of the remaining wavelengths, namely, λ₄ through λ₈ are reflected by the filter.

The reflected light is collected by the first collimating means 36 and focused on a sixth optical channel 78′ in the first waveguide concentrator 34. This optical channel 78′ couples the light into optical fiber 80 which conveys light to a seventh optical channel 82 in the first waveguide concentrator 34. The light from optical channel 82 is collimated and directed such light towards the filter at a fourth incidence angle α₄ to the normal direction.

The fourth incidence angle α₄ being different from the first α₁, second α₂ and third incident angle α₃ of optical channels 70, 74 and 78, respectively. The fourth incidence angle α₄ is chosen so that at wavelength λ₄ it is 0.8-nm for 100-GHz or 0.4-nm for 50-GHz longer than λ₃, and passes through the filter but light of the remaining wavelengths, namely, λ₅ through λ₈ are reflected by the filter.

This reflected light is collected by first collimating means 36 and focused on a eighth optical channel 82′ in the first waveguide concentrator 34. This optical channel 82′ couples the light into optical fiber 84 which conveys the light to a ninth optical channel 86 in the first waveguide concentrator 34. The light from optical channel 86 is collimated and directed such light towards the filter at the fifth incidence angle α₅ to the normal direction. The fifth incidence angle α₅ being different from the first α₁, second α₂, third α₃ and fourth α₄ incident angle of optical channels 70, 74, 78 and 82, respectively. The fifth incidence angle α₅ is chosen so that at wavelength λ₅ it is 0.8-nm for 100-GHz or 0.4-nm for 50-GHz longer than λ₄, and passes through the filter but light of the remaining wavelengths, namely, λ₆ through λ₈ are reflected by the filter.

This reflected light is collected by first collimating means 36 and focused on a tenth optical channel 86′ in the first waveguide concentrator 34. This optical channel couples the light into optical fiber 88 which conveys the light into a eleventh optical channel 90 in the first waveguide concentrator 34. The light from optical channel 90 will be collimated and directed such light towards the filter at the sixth incidence angle α₆ to the normal direction. The sixth incidence angle being different from the first α₁, second α₂, third α₃, fourth α₄ and fifth α₅ incident angle optical channels 70, 74, 78, 82 and 86, respectively. The sixth incidence angle α₆ is chosen so that at wavelength λ₆ it is 0.8-nm for 100-GHz or 0.4-nm for 50-GHz longer than λ₅, and passes through the filter but light of the remaining wavelengths, namely, λ₇ and λ₈ are reflected by the filter.

Such reflected light is collected by first collimating means 36 and focused on a twelfth optical channel 90′ in the first waveguide concentrator 34. This optical channel couples the light into optical fiber 92 which conveys the light into a thirteenth optical channel 94 in the first waveguide concentrator 34. The light from optical channel 94 is collimated and directed such light towards the filter at the seventh incidence angle α₇ to the normal direction. The seventh incidence angle α₇ being different from first through sixth incident angles α₁, α₂, α₃, α₄, α₅ and α₆ of optical channels 70, 74, 78, 82, 86 and 90, respectively. The seventh incidence angle α₇ is chosen so that at wavelength λ₇ it is 0.8-nm for 100-GHz or 0.4-nm for 50-GHz longer than λ₆, and passes through the filter but light of the remaining wavelength, namely, λ₈ is reflected by the filter.

The reflected light is collected by first collimating means 34 and focused on a fourteenth optical channel 94′ in the first waveguide concentrator 34. This optical channel couples the light into optical fiber 96 which conveys the light into a fifteenth optical channel 98 in the first waveguide concentrator 34. The light from optical channel 98 is collimated and directed such light towards the filter at the eighth incidence angle α₈ to the normal direction. The eighth incidence angle α₈ being different from first through seventh incident angle α₁, α₂, α₃, α₄, α₅, α₆ and λ₇ of optical channels 70, 74, 78, 82, 86, 90, and 94, respectively. The eighth incidence angle α₈ is chosen so that at wavelength λ₈ it is 0.8-nm for 100-GHz or 0.4-nm for 50-GHz longer than λ₇, and passes through the filter but light of the remaining wavelengths, namely, some noise is reflected by the filter.

As also illustrated in FIG. 2, not only does the light of the eight wavelengths pass through the filter at different angles, but light of each wavelength can be collected separately from the light of other wavelengths. Thus, as shown in FIG. 2 light of wavelengths λ₁ through λ₈ are collected by a second collimating means 40 and respectively focussed into eight optical channels in the second waveguide concentrator 42. Each of the optical channels in the second waveguide concentrator 42 couples the light into a corresponding output fiber so that light of the eight wavelengths is now carried separately by the eight optical fibers. It is, of course, possible for the system to separate light of more than one wavelength from light of other wavelengths at a time; all such variations are within the scope of the invention.

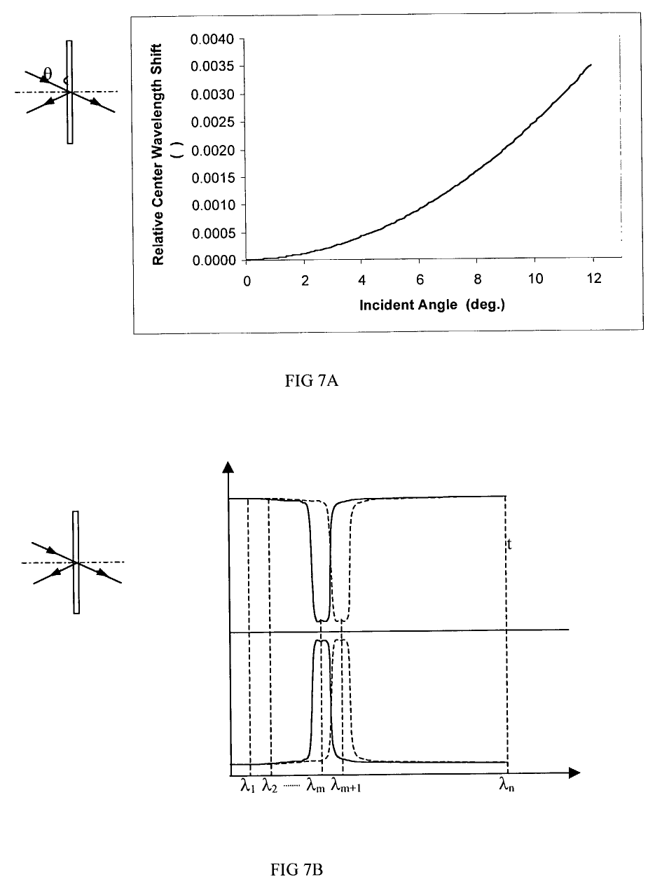

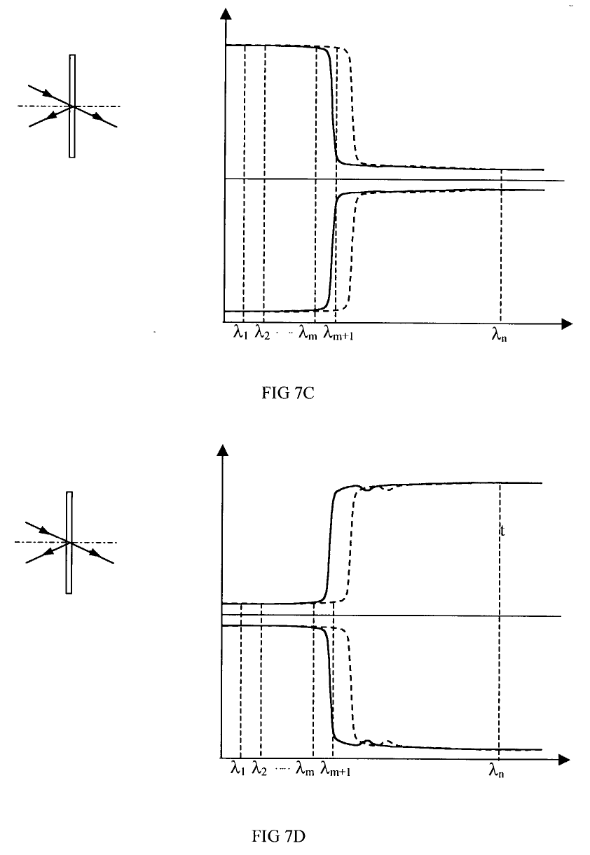

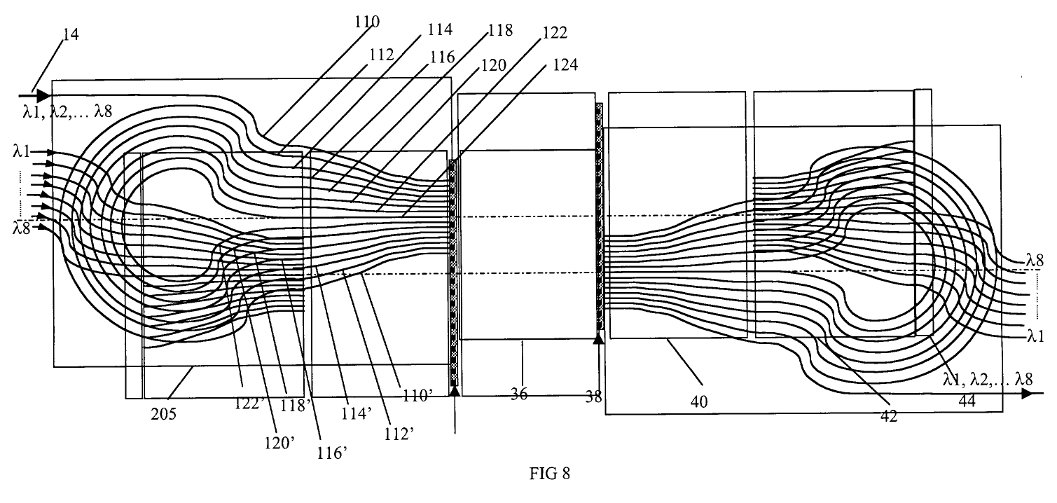

FIGS. 7B-7D illustrate schematically, various elements 38 which share the same common characteristic. This characteristic is that they pass incident light of wavelengths within a characteristic wavelength band and reflect incident light of wavelengths outside the band. In the preferred embodiment, the wavelength dependent element 38 is a thin film interference filter. This filter has a substantially flat surface so that a normal direction of incidence (or simply a normal direction) may be defined for the filter where the direction is normal to surface and pointing in the direction towards the filter. As is known, many filters have the characteristic that their characteristic wavelength band varies with the angle of incidence of the incident light to the normal incidence direction of the filter. An interference type filter has such characteristic. Thus, if λ₀ is the center wavelength of light that is passed by filter at zero angle of incidence (that is when light is directed to the filter along normal direction of filter), then the center wavelength λ_{θ} of the characteristic wavelength band of incident light at angle of incidence θ is given by the following equation:

λ_{θ}=λ₀=λ₀ (1−C sin θ)^{1/2}

Where C is the coefficient related to the effective refractive index of thin films in the thin film interference filter. From the above equations, we can see that when incident angle θ increases, the effective central wavelength (λ_{θ}) of the filter decreases. This relationship is graphically illustrated in FIG. 7A. It should be noted that the central wavelength (λ_{θ}) when the incident light is normal to the filter surface is generally the longest effective central wavelength (λ_{θ}) which will be provided for a specific filter structure. From the above equations, we can see that when incident angle θ increases, the effective central wavelength (λ_{θ}) of the filter decreases. In other words, one generally decreases the effective central wavelength (λ_{θ}) of the filter when one varies the incident angle θ away from 0°. For this reason, one will usually adjust the filter having the longer normal central wavelength to match the filter having the shorter normal central wavelength.

FIG. 7B illustrates the performance of a bandpass filter having the characteristic property that light of wavelength λₘ is within the passband while light of the remaining wavelengths in the input beam are in the rejection band. Therefore, only light of wavelengths λₘ is passed by filter and collected by the second collimating means 40. While light of the remaining wavelengths in the input beam are reflected by the filter 38 as a reflected beam. Therefore, by collecting light of the remaining wavelengths in the input beam by means of another lens and optical waveguide and fiber. Thus, if the input beam contains light of only two wavelengths (such as λₘ and λ₁) where one wavelength λₘ is in the passband and the other λ₁ in the rejection band of filter, then light of wavelength λₘ will pass through filter and be collected by second collimating means 40 and output waveguide/fiber, whereas light of wavelength λ₁ will be reflected by filter and collected by the first collimating means and the first waveguide concentrator means.

FIG. 7C illustrates the performance of a long-pass edge filter with pass and rejection. In the case of the long-pass edge filter, light of wavelengths λₘ₊₁ to λₙ are in the pass band while light of the remaining wavelengths in the input beam λ₁ through λₘ are in the rejection band, so that only light in the pass band will pass through the filter, and collected by collimating lens and fiber whereas light of the remaining wavelengths λ₁ through λₘ are reflected by filter and can be collected as a collected beam. As in the case of the bandpass filter in FIG. 4B, if the input beam contains only light of two wavelengths and if one wavelength is in the passband while the other wavelength is in the rejection band, the directing the input beam at filter once is adequate to separate light of the two wavelengths into an pass beam and an reflected beam.

FIG. 7D illustrates the peformance of a short-pass edge filter with pass and rejection bands. In the case of the shortpass edge filter, light of wavelengths λ₁ to λₘ are in the pass-band while light of the remaining wavelengths in the input beam λₘ₊₁ through λₙ are in the rejection band, so that only light in the pass band will pass through the filter, and collected by collimating lens and fiber whereas light of the remaining wavelengths λₘ₊₁ through λₙ are reflected by filter and can be collected as a collected beam. As in the case of the long-pass filter in FIG. 7C, if the input beam contains only light of two wavelengths and if one wavelength is in the passband while the other wavelength is in the rejection band, the directing the input beam at filter once is adequate to separate light of the two wavelengths into an pass beam and an reflected beam.

If the input beam contains light of more than two wavelengths, it will be necessary to direct light of different wavelengths that have not been separated by such process to the same filter again with different angle as described below or a different filter to further separated and demultiplex light of such wavelengths. This process is the same for bandpass filter, longpass filter, and shortpass filter in FIG. 7B to FIG. 7D.

As shown in FIG. 7B to FIG. 7D, the angle of incidence of input beam is at a non-zero angle to the normal direction. This means that the characteristic wavelength band of filter has been shifted to the left relative to the characteristic wavelength band of filter when the angle of incidence is zero; that is, the pass and rejection bands of filter covers now a range of wavelengths that are shorter than those corresponding to a zero angle of incidence. From FIG. 7B, it will be apparent that what would be passed at normal angle of incidence would now be rejected and specially reflected by the filter where the angle of incidence is not zero as illustrated in FIG. 7B. Therefore, by choosing the angle of incidence, it is possible to selectively pass light of one wavelength while selectively reflecting light of other wavelength. The same is true for the long-pass edge filter and short-pass edge filter of FIG. 7C and FIG. 7D.

FIG. 3 is a schematic view of a multiplexer to illustrate another embodiment of the invention. As shown in FIG. 3, the multiplexer includes a filter (wavelength dependent element 38), which may be a bandpass, short-pass or long-pass edge filter, a first and a second waveguide concentrator 34, 42, a first and second collimating means, 36 and 40, which are preferably GRIN lenses, and input and output optical fibers. The operation of multiplexer is apparent from the explanation given above for the demultiplexer.

In general terms, the input light from all input channels 1 to N, (where N equals 8 in this example, and there are eight wavelengths, λ₁ . . . λ₈), is collimated by the first collimating means 36 and directed towards a location in the wavelength dependent element 38 at an angle of incidence λ₁ . . . λ₈, respectively. The incidence angle λ₁ . . . λ₈ characterized such that the corresponding light of wavelengths λ₁ . . . λ₈ will pass through the wavelength dependent elements 38. This light is refocused by a second collimating means 40 and focused into optical channels 104, 105, 106, 107, 108, 109, 110 and 111 respectively.

The light of wavelength λ₁ (where N=1) is focused into waveguide 104 of the second waveguide concentrator 42 and coupled into the output fiber 200.

The light of wavelength λ₂ (where N=2) is focused into waveguide 105, coupled into optical fiber 112, and conveyed into waveguide 105′ of the second waveguide concentrator 42. The light from 105′ is collimated by the second collimating means 40 and directed towards a location of the wavelength dependent element 38 at an angle λ₁, in this case the 1st angle of incidence). The incidence angle λ₁ being such that light of wavelength λ₂ will be reflected. This reflected light is collected by the second collimating means 40 and focused into waveguide 104 in the second waveguide concentrator 42 and coupled into the output optical fiber 200.

The light of wavelength λ₃ (where N=3) is focused into waveguide 106, coupled into optical fiber 113, and conveyed into waveguide 106′ of the second waveguide concentrator 42. The light from 106′ is collimated by the second collimating means 40 and directed towards a location of the wavelength dependent element 38 at an angle λ₂. The incidence angle λ₂ (the N-1, or 2^{nd} angle of incidence) being such that light of wavelength λ₃ will be reflected. This reflected light is collected by the second collimating means 40 and focused into waveguide 105 in the second waveguide concentrator 42 and coupled into the output optical fiber 112. The light from optical fiber 112 is conveyed into waveguide 105′, collimated by the second collimating means 40 and directed towards a location of the wavelength dependent element 38 at an angle λ₁. The incidence angle λ₁ being such that light of wavelength 3 will be reflected. This reflected light is collected by the second collimating means 40 and focused into waveguide 104 (the 1^{st} waveguide) in the second waveguide concentrator 42 and coupled into the 1^{st} output optical fiber 200.

The light of wavelength λ₄ is focused into waveguide 107, coupled into optical fiber 114, and conveyed into waveguide 107′ of the second waveguide concentrator 42. The light from 107′ is collimated by the second collimating means 40 and directed towards a location of the wavelength dependent element 38 at an angle λ₃. The incidence angle λ₃ being such that light of wavelength λ₄ will be reflected. This reflected light is collected by the second collimating means 40 and focused into waveguide 106 in the second waveguide concentrator 42 and coupled into the output optical fiber 113. The light from optical fiber 113 is conveyed into waveguide 106′ of the second waveguide concentrator 42, collimated by the second collimating means 40 and directed towards a location of the wavelength dependent element 38 at an angle λ₂. The incidence angle λ₂ being such that light of wavelength λ₄ will be reflected. This reflected light is collected by the second collimating means 40 and focused into waveguide 105 in the second waveguide concentrator 42 and coupled into the output optical fiber 112. The light from optical fiber 112 is conveyed into waveguide 105′ of the second waveguide concentrator 42, collimated by the second collimating means 40 and directed towards a location of the wavelength dependent element 38 at an angle λ₁. The incidence angle λ₁ being such that light of wavelength λ₄ will be reflected. This reflected light is collected by the second collimating means 40 and focused into waveguide 104 in the second waveguide concentrator 42 and coupled into the output optical fiber 200.

From the above explanation, it will be apparent that wavelengths λ₅ to λ₈ are similarly eventually reflected and focused into waveguide 104 of the second waveguide concentrator 42 and coupled into the output optical fiber 200.

It can be seen that if process is repeated in this manner, each time adding one wavelength into the multiplexing beam, finally all of eight wavelengths λ₁ through λ₈ emerge into a single beam. This light beam of wavelength, λ₁, through λ₈, is focused by the second collimating means 42 into a waveguide in second waveguide concentrator and couple into output fiber 200 as the output multiplexer.

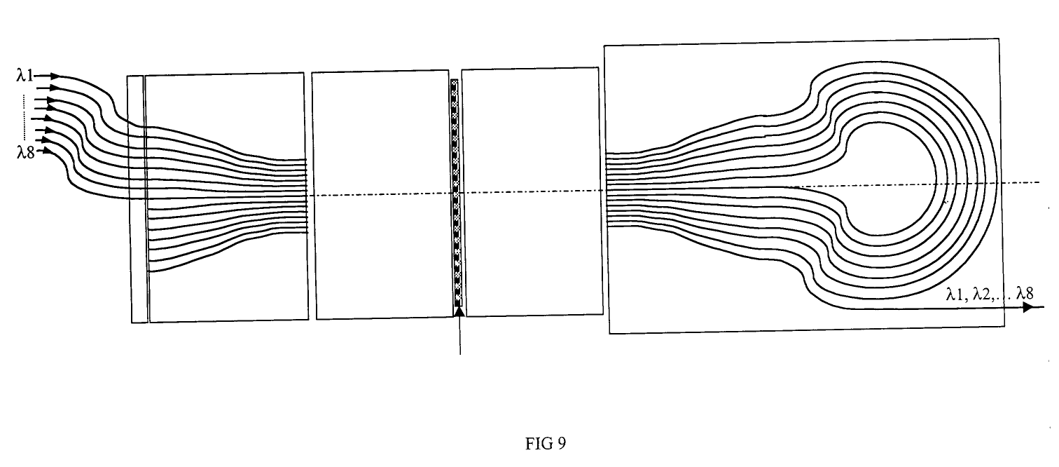

A further embodiment of the invention is illustrated in FIG. 8. As illustrated, the architecture is similar to the architecture illustrated in FIG. 2 for the demultiplexer described above, but incorporates an integrated planar waveguide circuit 205. The main difference here is that the functionality of the first waveguide concentrator 34, the planar array of optical channels 32 and the optical fibers 14, 72, 76, 80, 84, 88, 92 and 96 illustrated in FIG. 2 are all integrated onto a single chip, the integrated planar waveguide circuit 205. Light in optical channels 110, 112, 114, 116, 118, 120, 122, and 124 is collimated by the first collimating means 36 and directed towards the wavelength dependent element 38, at substantially the same angles as described above for FIG. 2. The optical channels 110′, 112′, 114′, 116′, 118′, 120′, and 122′collect the reflected light via filter 38, in a similar manner to that described in relation to FIG. 2. However, as illustrated in FIG. 8, the light, once in optical channels 110′, 112′, 114′, 116′, 118′, 120′, and 122′, does not need to couple into an optical fiber in order to enable routing and coupling back into optical channels 112, 114, 116, 118, 120, 122, and 124 respectively to occur. The light from waveguide 110 to waveguide 122 can be routed inside the integrated planar waveguide circuit 205.

This type of architecture preferably results in the creation of an integrated optical circuit, rather than a circuit consisting entirely of discrete components. Strictly speaking, integrated optical circuits are optical circuits that have optical functions fabricated or integrated onto/into a planar substrate. As commonly used, the term integrated circuits includes both monolithic and hybrid circuits. In monolithic circuits, all the components used for the device, such as waveguide circuits and output optical circuitry are integrated on a single substrate. In the case of hybrid circuits, at least one additional component (which may or may not be a chip) is coupled with at least one integrated optical circuit. Integrated optical circuits typically have a number of advantages over conventional optical systems composed of discrete elements. These advantages include reduced loss (since alignment issues are subject to better control), and smaller size, weight, and power consumption. In addition, there is the improved reliability, the reduction of effects caused by vibration, and the possibility of batch fabrication, leading ultimately to reduced cost to the customer. Trading off against these advantages is the requirement that the fabrication processes are applied sequentially to the same substrate. As a result, process steps must be compatible with the results of preceding steps. In cases where process steps may be incompatible, multiple separate components may be used in a hybrid configuration. Then the compatibility requirement applies separately to each component, but the alignment and reliability issues become more difficult. Clearly the tradeoff between these factors requires a detailed analysis in each separate case.

The waveguides are designed such that the waveguide index difference and route circuit curve to minimize the insertion loss.

Similarly, FIG. 9 is a schematic view of multiplexer using one planar waveguide circuit instead of second waveguide concentrator in FIG. 3. At one end of waveguide closed to collimating lens, the waveguide position is the same as the waveguide concentrator in FIG. 3. The light signals in waveguides are collimated and directed towards the filter at substantially the same angles as describe above for FIG. 3. Here, the light in the waveguides does not have to couple into fiber and route and couple back into waveguide. The light from one waveguide to another waveguide with opposite propagation direction is routed inside planar waveguide. The route circuit curve and waveguide index difference can be designed to minimize the insertion loss. The planar waveguide circuit design can simplify light coupling process, using single waveguide to single fiber coupling instead of the array coupling between fibers and waveguides. The demultiplexer/multiplexer are more compact due to eliminating fiber splicing. This approach eliminates a lot of coupling loss between fiber and waveguide, as well.

While the above is a complete description of the preferred embodiments of the present invention, various alternative modifications, and equivalents may be used. It should be evident that the present invention is equally applicable by making appropriate modifications to the embodiment described above. Therefore, the scope of the invention should be determined, not by examples given, but by the appended claims and their legal equivalents.

What is claimed is:

1. A dense wavelength division multiplexer comprising:
(a) a planar array of input optical channels, including at least two input channels, each of the input channels capable of receiving an optical signal;
(b) a first waveguide concentrator for facilitating the reduction of spacing between the input optical channels, the first concentrator having first and second end faces, the first end face coupled to the planar array;
(b) a first collimating means for transforming the optical signals into a collimated beam, the first collimating means having first and second end faces, the first end face of the first collimating means coupled to the second end face of the first waveguide concentrator;
(d) a wavelength dependent element having an input and an output face, and disposed such that the input face is proximate the second end face of the first collimating means;
(e) a second collimating means for refocusing the collimated beam into an optical channel, the second collimating means having first and second end faces, the first end face coupled to the output face of the wavelength dependent element; and
(f) a second waveguide concentrator for facilitating the expansion of spacing between output channels, the second concentrator having first and second end faces, the first end face coupled to the second end face of the second collimating means, wherein the array of output optical channels, including at least two output channels, and coupled to the second end face of the second waveguide concentrator.

2. A dense wavelength division multiplexer according to claim 1 wherein the first and second collimating means comprises a GRaded INdex lens.

3. A dense wavelength division multiplexer according to claim 1 wherein the wavelength dependent element comprises a multi-layer dielectric interference filter.

4. A dense wavelength division multiplexer according to claim 1, wherein the planar array of input optical channels and the first waveguide concentrator are integrated.

5. A dense wavelength division multiplexer according to claim 1, wherein the second waveguide concentrator and the array of output optical channels are integrated.

6. A dense wavelength division demultiplexer comprising:
(a) a planar array of input optical channels, including at least two input channels, each of the input channels capable of receiving an optical signal;
(b) a first waveguide concentrator for facilitating the reduction of spacing between the input optical channels, the first concentrator having first and second end faces, the first end face coupled to the planar array;
(c) a first collimating means for transforming the optical signals into a collimated beam, the first collimating means having first and second end faces, the first end face of the first collimating means coupled to the second end face of the first waveguide concentrator;
(d) a wavelength dependent element having an input and an output face, and disposed such that the input face is proximate the second end face of the first collimating means; and
(e) a second collimating means for refocusing the collimated beam into an optical channel, the second collimating means having first and second end faces, the first end face coupled to the output face of the wavelength dependent element; and
(f) a second waveguide concentrator for facilitating the expansion of spacing between output channels, the second concentrator having first and second end faces, the first end face coupled to the second end face of the second collimating means, wherein the array of output optical channels, including at least two output channels, and coupled to the second end face of the second waveguide concentrator.

7. A dense wavelength division demultiplexer according to claim 6 wherein the first and second collimating means comprises a GRaded INdex lens.

8. A dense wavelength division demultiplexer according to claim 6 wherein the wavelength dependent element comprises a multi-layer dielectric interference filter.

9. A dense wavelength division demultiplexer according to claim 6, wherein the planar array of input optical channels and the first waveguide concentrator are integrated.

10. A dense wavelength division demultiplexer according to claim 6, wherein the second waveguide concentrator and the array of output optical channels are integrated.

11. A method for demultiplexing light of a plurality of wavelengths in an input beam by means of a wavelength dependent element, the wavelength dependent element or filter having the property that light of a predetermined wavelength passes through the element or filter at a predetermined incident angle, and substantially all other light is reflected by the element, and wherein the predetermined wavelength varies with the angle of incidence of the input beam to the normal direction of the element or filter, the method comprising:
(a) directing a first input beam of a planar array, through a first waveguide in a first waveguide concentrator, through a first collimating lens, and towards the element or filter with a first incident angle so that light of a first wavelength is substantially passed by the element, passes through a second collimating lens, is coupled into the second waveguide concentrator and into the corresponding output fiber and light of substantially all other wavelengths than the first wavelength is substantially reflected;
(b) collimating the reflected light of substantially all other wavelengths than the first wavelength, and coupling the reflected light into the first waveguide concentrator, routing the reflected light into second waveguide in the first waveguide concentrator, the light in the second waveguide in the first waveguide concentrator being a second input beam;
(c) directing the second input beam through a second waveguide in the first waveguide concentrator, through the first collimating lens, and towards the element with a second incident angle, differing from the first incident angle so that light of a second wavelength differing from the first wavelength is substantially passed by the element, passes through the second collimating lens, is coupled into the second waveguide concentrator and into the corresponding output fiber, and light of substantially all wavelengths other than the second wavelength is substantially reflected;
(d) collimating the reflected light of substantially all other wavelengths than the second wavelength, and coupling the reflected light into the first waveguide concentrator, routing the reflected light into third waveguide in the first waveguide concentrator, the light in the third waveguide in the first waveguide concentrator being a third input beam; and
(e) repeating steps (a) to (d) each time removing one wavelength into the demultiplexing beam, until all wavelengths λ₁ through λ_{N} emerge as discrete beams, in a planar array.
